(19) United States
(12) Patent Application Publication
(10) Pub. No.: US 2005/0157332 A1
(43) Pub. Date: Jul. 21, 2005

(54) Portable printer for digital camera

(75) Inventors: Jung-Min Han, Seoul (KR); Mi-Sun Kim, Seoul (KR); Hee-Sun Tak, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/034,953

(22) Filed: Jan. 14, 2005

(30) Foreign Application Priority Data
Jan. 16, 2004 (KR) 2004-3267

(51) Int. Cl. G06F 15/00

(52) U.S. Cl. 358/1.15; 358/1.9; 358/479

(57) ABSTRACT

A portable printer for a digital imaging apparatus, in which sound and image information stored to the digital imaging apparatus can be displayed through a wide screen and printed even in a place without a computer. The information can be backed up in the information storage medium equipped in the portable printer. The portable printer includes a printer body, a display part openly mounted to the printer body to output images and moving images recorded to the digital imaging apparatus. An information storage medium is detachably mounted to the printer body to store the images recorded to the digital imaging apparatus, and an output part is mounted to the printer body to output to a printing medium the images recorded to the digital imaging apparatus.

### CROSS-REFERENCE TO RELATED APPLICATIONS

This application claims the benefit under 35 U.S.C. § 119(a) of Korean Patent Application No. 2004-3267, filed Jan. 16, 2004, in the Korean Intellectual Property Office, the entire disclosure of which is hereby incorporated by reference.

### BACKGROUND OF THE INVENTION

1. Field of the Invention

The present invention relates to a portable printer. More particularly, the present invention relates to a portable printer for a digital imaging apparatus, that is connected wirelessly or by wire to the digital imaging.

2. Description of the Related Art

Generally, digital cameras or digital camcorders use a small nonvolatile memory such as a flash memory for a storage medium. Accordingly, the main bodies of digital cameras and camcorders are more compact and light compared to bodies of conventional camcorders using magnetic tape.

However, these digital cameras and digital camcorders require wiring or wireless connection to a computer having a predetermined program for retrieving output sound and image information stored therein. For example, in order to connect the aforementioned digital cameras or digital camcorders to a universal serial bus (USB) which is the prevailing connection interface standard of the Institute of Electrical and Electronics Engineers (IEEE) 1334, to a computer by wire, the computer normally applies such a predetermined program interface. Also, appropriate and dedicated software is necessary for reading the sound and image information. If the computer cannot apply the interface or does not have the dedicated software, the information recorded in the digital camera or digital imaging apparatus cannot be read. Therefore, since such digital apparatuses are usually used outdoors, it is difficult to search with a wide screen and output to a printing medium the recorded sound and image information.

Accordingly, a portable device is in demand, which is capable of searching the sound and image information recorded in the digital camera or digital camcorders. Moreover, a portable device is in demand, which is capable of doing so through a wide screen and outputting information to the printing medium even where the dedicated computer is not equipped, such as outdoors.

Accordingly, there is a need for an improved wireless or wire portable printer for a digital imaging apparatus.

### SUMMARY OF THE INVENTION

An aspect of the present invention is to solve at least some of the aforementioned problems and/or disadvantages and to provide other advantages that will be appreciated by those of ordinary skill in the art. Accordingly, embodiments of the present invention provide a portable printer for a digital imaging apparatus, which is capable of wired or wireless communication with a digital camcorder.

Another object of the present invention is to provide a portable printer that does not have to be connected to a computer, and can record to an information storage medium for printing sound and image information stored to the digital imaging apparatus.

The foregoing and other objects and advantages are substantially realized by providing a portable printer for a digital imaging apparatus, connected by wire or wirelessly to the digital imaging apparatus for receiving information on still or moving images. The images are recorded to the digital imaging apparatus. The portable printer includes a printer body, a display part openly mounted to the printer body for outputting the recorded images from the digital imaging apparatus, an information storage medium detachably mounted to the printer body for storing the image information recorded to the digital imaging apparatus, and an output unit mounted to the printer body for outputting to a printer medium the image information recorded to the digital imaging apparatus.

The display panel is a thin film transistor (TFT), liquid crystal display (LCD) having a touch-screen function.

The information storage medium is a blue-ray disc.

The printer body includes a receiving recess for detachably mounting the digital imaging apparatus. Other objects, advantages, and salient features of the invention will become apparent to those skilled in the art from the following detailed description, which, taken in conjunction with the annexed drawings, discloses preferred embodiments of the invention.

### BRIEF DESCRIPTION OF THE DRAWING FIGURES

The above aspects and other features of the present invention will become more apparent from the following detailed description of exemplary embodiments taken in conjunction with the accompanying drawings, in which;

FIG. 1 is a perspective view of a portable printer for a digital imaging apparatus in accordance with an embodiment of the present invention;

FIG. 2 is a rear view of a portable printer for a digital imaging apparatus of FIG. 1 in a standing posture;

FIG. 3 is a front view of a portable printer for a digital imaging apparatus of FIG. 1 provided with an information storage medium and an output unit;

FIG. 4 is a perspective view of a portable printer for a digital imaging apparatus of FIG. 1, in use with the digital imaging apparatus is being received;

FIG. 5 is a perspective view of a portable printer for a digital imaging apparatus in which a receiving function of the digital imaging apparatus is performed wirelessly, in accordance with another embodiment of the present invention; and

FIG. 6 shows a display panel of the portable printer of FIG. 5, operating with a touch-screen, using a stylus pen.

Throughout the drawings, the same drawing reference numerals will be understood to refer to the same elements, features, and structures.

### DETAILED DESCRIPTION OF THE EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions or constructions are omitted for conciseness.

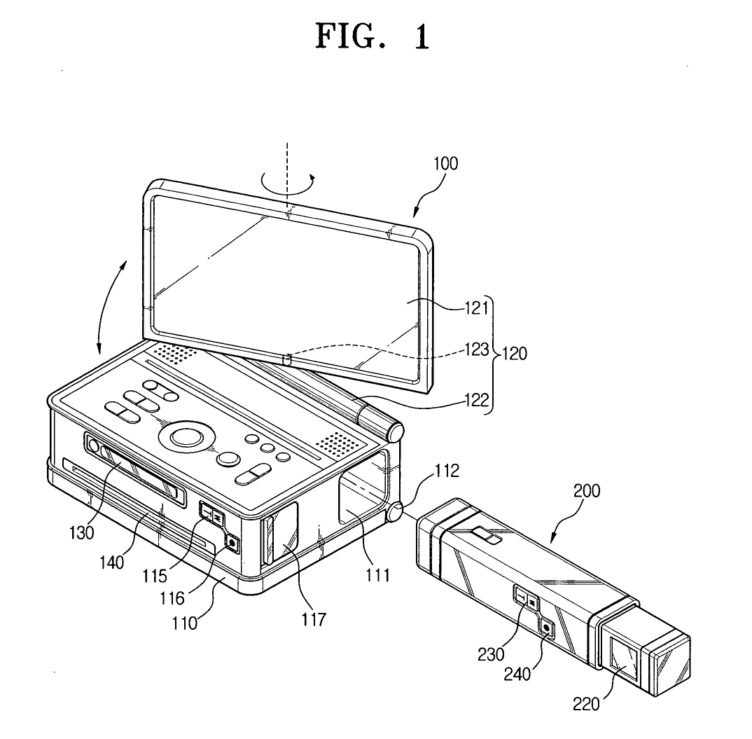

Referring to FIGS. 1-3, a portable printer 100 for a digital imaging apparatus is disclosed having a printer body 110, a display part 120, an information storage medium 130 and an output unit 140 to reproduce and output a still and moving images which are stored to a digital imaging apparatus 200. The output unit 140 prints the still and moving images to a printing medium. Typically, printing refers to the process of printing a still image onto a printing medium. However, printing of a moving image can also be accomplished by selecting one or more frames of the moving image to be printed onto a printing medium. Therefore, in this application, printing of a moving image will refer to printing one or more frames of the moving image. The digital imaging apparatus 200 comprises a camera unit 210 on the front thereof and a small-sized viewfinder 220 on the rear thereof.

According to an exemplary embodiment of the present invention, the printer body 110 of the portable printer 100 has a receiving recess 111 for detachably mounting the digital imaging apparatus 200. The digital imaging apparatus 200 can be completely inserted in the receiving recess 111, thereby being received into the printer body 110.

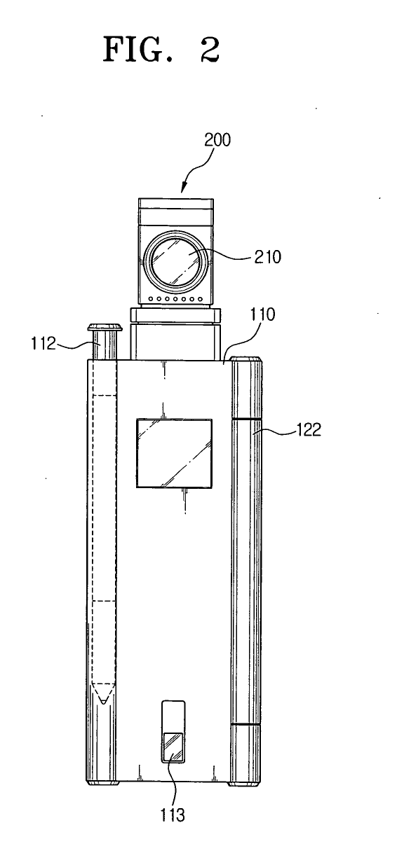

As shown in FIG. 2, the printer body 110 has a removable stylus pen 112 for touching the display part 120. A separation switch 113 is formed at one side of the printer body 110, so that when a user pushes the separation switch 113, the digital imaging apparatus 200 is protruded out of the printer body 110.

The display part 120 a display panel 121, a pivot shaft 122 and a connection projection 123. The display panel 121 outputs an image stored to the digital imaging apparatus 200 and pivots on the pivot shaft 122 with respect to the printer body 110.

Both ends of the pivot shaft 122 are hinged to the printer body 110, respectively, and in the middle of the pivot shaft 122, the connection projection 123 is formed in a substantially perpendicular direction to the pivot shaft 122.

The display panel 121 is pivotably engaged with the pivot shaft 122 by the connection projection 123. The display panel 121 is preferably a thin film transistor (TFT)-liquid crystal display (LCD) and has conventional touch screen functions and capabilities. Accordingly, as shown in FIG. 1, the display panel 121 can rotate about the connection projection 123 as well as pivot in opening and closing manner with respect to the printer body 110.

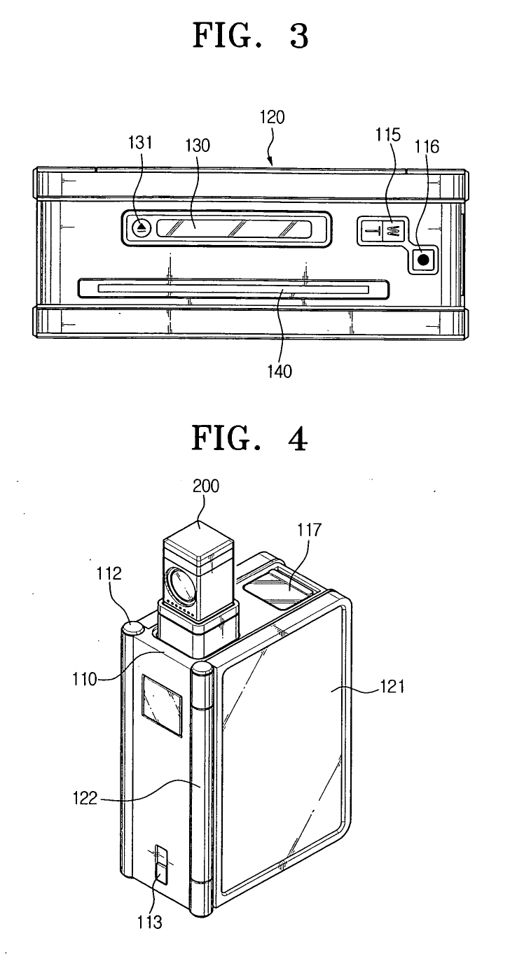

As shown in FIG. 3, a cartridge-type optical disc, such as a blue-ray disc sold under the trademark BLU-RAY™, may be used for the information storage medium 130. The blue-ray disc uses a 405 nm-wavelength blueviolet laser of much higher density compared to a conventional digital versatile disc (DVD) which uses a 650 nm-wvelength red laser. The blue-ray disc is able to store 23.3 G; 25 G and 27 G which are approximately 5˜6 times of capacity of conventional DVDs to a disc of 1.2 mm thickness, a 12 cm diameter and a 0.1 mm of recording layer. In the blue-ray disc, a laser transmitted through a lens is minutely irradiated to an optical disc, and a lens numerical aperture (NA) that greatly influences the increase of data storing density is 0.85. Therefore, by applying a single side/dual layer technology in which two recording layers are formed on one side of a disc, the blue-ray disc can store up to 50 G which is nearly 10 times of capacity of the conventional DVDs.

As the NA is high, a track pitch is also very small, that is, on the order of 0.32 μm which is less than a half of that of the conventional DVD. Being applied to an optical drive, the single side/dual layer technology enables data transmission 3˜5 times as fast as conventional DVD-read only memory (ROM) drives and compact disc (CD)-ROM drives which transmit respectively 11.12 Mbps and 7 Mbps per second.

In addition, since a video/audio data format uses a moving picture experts group (MPEG)-2 (video), AC3·MPEG1 layer 2 (audio) used in the conventional DVD, no problem occurs in compatibility. Also, since a disc cartridge of a 129×131×7 mm size is applicable when manufacturing a high definition (HD)-DVD drive which effectively protects data, the data can be recorded and reproduced with most of conventional DVD discs.

Output unit 140 outputs the image stored to the digital imaging apparatus 200 to a printing medium The output unit 140 can be implemented by a dye sublimation photo-printer.

Hereinafter, the operation of the above-structured portable printer for a digital imaging apparatus, according to an exemplary embodiment of the present invention, will be described with reference to the accompanying drawings. As stated above, the portable printer 100 is adapted for storing and outputting still and moving images stored to the digital imaging apparatus 200. According to an exemplary embodiment of the present invention, the printer body 110 comprises the receiving recess 111 for mounting the digital imaging apparatus 200. FIG. 4 illustrates the portable printer 100 in use, wherein the digital imaging apparatus 200 is received into the printer body 110.

Referring to FIG. 4, a user can photograph still and moving images with the digital imaging apparatus 200 partially exposed from the printer body 110. In this position, a photographed image can advantageously be viewed through the display panel 121 instead of the small viewfinder 220 provided in the digital imaging apparatus 200. Also, transmission of the data can be performed in a state in which the digital imaging apparatus 200 is inserted in the receiving recess 111.

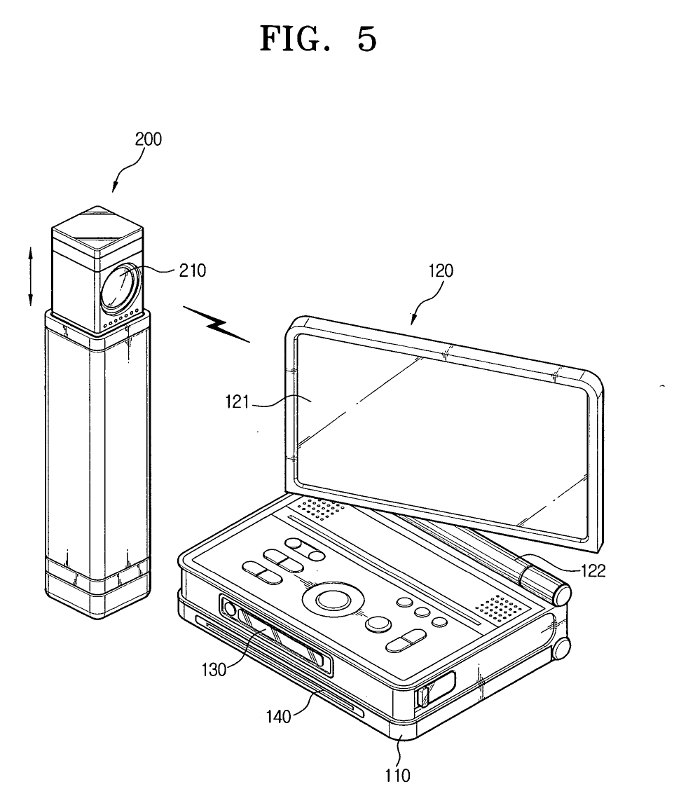

FIG. 5 illustrates another embodiment of the portable printer 100. In this embodiment, the receiving recess 111 for receiving the digital imaging apparatus 200 is not provided. Therefore, the data stored to the digital imaging apparatus 200 is transmitted to the printer body 110 through a wireless data communicating device such as wireless technology sold under the trademark BLUETOOTH™.

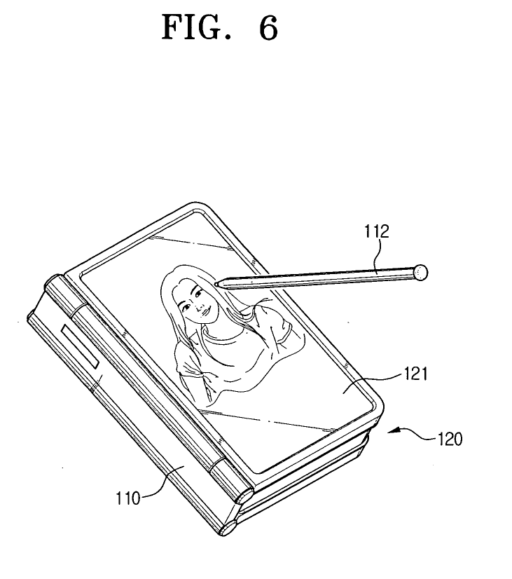

FIG. 6 illustrates another manner of use for the portable printer 100 for the digital imaging apparatus 200. The display part 120 is used as being exposed and folded back toward the printer 110, as shown in FIG. 6. In this case, the display panel 121 may be implemented by as a touch-screen, and therefore, the user can conveniently select a menu and the like, using a dedicated stylus pen 112 provided to the printer body 110.

With the above-structured portable printer 100 for the digital imaging apparatus 200, sound and image information stored to the digital imaging apparatus 200 can be displayed through a wide screen and printed without a computer. Furthermore, the information can be transferred to and backed up in the information storage medium 130 equipped in the portable printer 100.

While the invention has been shown and described with reference to certain embodiments thereof, it will be understood by those skilled in the art that various changes in form and details may be made therein without departing from the spirit and scope of the invention as defined by the appended claims.

1. A portable printer for a digital imaging apparatus, connected by wire or wirelessly to the digital imaging apparatus for receiving information comprising still or moving images, the images being recorded to the digital imaging apparatus, the portable printer comprising:
a printer body;
a display part mounted to the printer body for outputting the recorded still or moving images from the digital imaging apparatus;
an information storage medium detachably mounted to the printer body for storing image information recorded to the digital imaging apparatus; and
an output unit mounted to the printer body for outputting to a printing medium the still or moving image information recorded to the digital imaging apparatus.

2. The portable printer of claim 1, wherein
the display part is rotatably mounted to the printer body.

3. The portable printer of claim 1, wherein
the display part comprises a display panel, a pivot shaft for pivotally opening and closing the display panel with respect to the printer body; and
a connection projection formed on the pivot shaft extending in a direction substantially perpendicular to the pivot shaft for linking the display panel with the pivot shaft, and
whereby the display panel is pivotably mounted by the connection projection.

4. The portable printer of claim 3, wherein the display panel is a thin film transistor (TFT)—liquid crystal display (LCD).

5. The portable printer of claim 4, wherein
the display panel has a touch-screen function.

6. The portable printer of claim 3, wherein
the display panel has a touch screen function.

7. The portable printer of claim 1, wherein
the information storage medium is an optical disc.

8. The portable printer of claim 1, wherein
the information storage medium is a blue-ray disc.

9. The portable printer of claim 1, wherein
the printer body includes a receiving recess for detachably mounting the digital imaging apparatus.

10. The portable printer of claim 1, wherein
a removable stylus pen for touching the display part is disposed on the printer body.

11. The portable printer of claim 1, wherein
a separation switch is formed on a side of the printer body for releasing the digital imaging apparatus.

12. The portable printer of claim 1, wherein
the digital image apparatus has front and rear surfaces, a camera unit is disposed on the front surface, and a viewfinder is disposed on the rear surface.
